(19) United States
(12) Patent Application Publication
(10) Pub. No.: US 2012/0262104 A1
(43) Pub. Date: Oct. 18, 2012

(54) CHARGE METHODS FOR VEHICLES

(75) Inventor: David M. Kirsch, Torrance, CA (US)

(73) Assignee: Honda Motor Co., Ltd.

(21) Appl. No.: 13/086,654

(22) Filed: Apr. 14, 2011

(51) Int. Cl. H02J 7/00

(52) U.S. Cl. 320/101

(57) ABSTRACT

A method for determining the state of charge of a vehicle at least partially electrically powered and rechargeable by at least one solar panel. The method utilizes a computer system including one or more processors and memory storing one or more programs to perform the following operations at the time the vehicle is turned off. A current status of charge of the vehicle is measured and a charging predictor is selected from at least one of the vehicles, geographic location, date, time, vehicle tilt angle, weather conditions and solar panel efficiency. An estimated charging schedule based on said current state of charge and the charging predictor is calculated and transmitted to a remote location or the current state of charge and charging predictor transmitted to a remote location while an estimated charging schedule is calculated.

### BACKGROUND

The present exemplary embodiment relates to charging protocols for electric or hybrid vehicles. However, it is to be appreciated that the present exemplary embodiment is also amenable to other similar applications.

Electric vehicles are powered by an electric motor to which electricity is provided by a group of batteries. Operation of the motor depletes energy stored in the batteries. Electric vehicles are typically recharged from an external power source. For example, the electric vehicle can be recharged at a home or office location by being plugged into a standard outlet. Also, commercial fast charging stations are becoming more commonly available where a higher current charge can be delivered.

A hybrid vehicle operates using both hydrocarbon fuel and electric power. A conventional engine is fueled by the hydrocarbon fuel while an electric motor is powered by a battery. The engine may operate a generator which charges the battery at times when the full power of the engine is not needed to propel the vehicle.

A plug-in hybrid is a hybrid vehicle in which the driver has the option of plugging the vehicle into exterior electric power when it is parked so that the battery does not have to be charged by the engine.

Solar vehicles are used herein to refer to electric and hybrid vehicles which have one or more solar panels on the body to provide part of the electricity for the electric motor and/or for charging the batteries and further to any vehicle including one or more solar panels that provide electrical power to a vehicle accessory, such as a radio or the vehicle's heating, ventilating and air conditioning system. A typical car belonging to an individual is parked 90% of the time. Therefore, solar charging can provide a significant portion of the energy used. In the case of an electric vehicle, the solar vehicle would likely also be a plug-in, so if sunlight is unavailable for any reason (weather, parked underground etc.) the battery can be charged from grid power. In the case of a hybrid vehicle, the battery of the solar hybrid can be charged by the solar panels and by the engine and perhaps also as a plug-in.

An exemplary electric vehicle including solar panels is depicted in FIG. 1. More particularly, vehicle 10 includes storage batteries 12 mounted within the vehicle. A plurality of solar panels 14 are located on the hood and roof to convert incident solar radiation into electrical energy. The solar panels 14 are electrically connected to the storage batteries 12 and are operative to supply electrical current thereto for recharging.

Electric and hybrid vehicles require significant automated control to provide efficient and reliable performance. A controller is therefore provided. A controller may be formed by one or more processors associated with the vehicle. In a hybrid vehicle, the controller runs an optimized control algorithm that determines on a moment-to-moment basis when to use either the engine, the motor or both; in what ratio, and also when to charge the battery from the engine. In pure electric and solar hybrids, the controller also makes decisions about how and when to recharge the battery.

Remote communication to and from vehicles has been known for years. For example, GPS and/or satellite technology can be used to guide vehicles and send information regarding location, mapping, guidance, and possible vehicle crashes to a remote location for contacting emergency services and the like. Many vehicles also have internal local area wireless networks, such that cell phones may be used in a hands free mode by the vehicle operator. Many of these systems rely on cellular communication devices and/or satellite devices to communicate between the vehicle and an external service center or from the vehicle to existing cellular networks or hard line telephones.

These forms of communication can provide an interface for an electric vehicle or a plug-in hybrid electric vehicle. Moreover, a communication interface system for a plug in electric vehicle that relies on battery power to propel the vehicle is provided. A communication interface for an electric vehicle or plug-in hybrid vehicle that will be able to control remotely the charging of the battery is similarly provided. There also provided a communication interface for an electric vehicle or plug-in hybrid vehicle that will notify the user of any potential problems during the charging of the vehicle.

One shortcoming of the current systems is a reliance on cellular or satellite communication for operation. Accordingly, if these communication systems are unavailable, the vehicle operator may have no ability to access the state of charge of a vehicle for operation.

### BRIEF DESCRIPTION

Various details of the present disclosure are hereinafter summarized to provide a basic understanding. This summary is not an extensive overview of the disclosure, and is intended neither to identify certain elements of the disclosure, nor to delineate the scope thereof. Rather, the primary purpose of this summary is to present some concepts of the disclosure in a simplified form prior to the more detailed description that is presented hereinafter.

According to a first embodiment, a method for determining the state of charge of an at least partially electrically powered vehicle is provided. The vehicle is rechargeable by at least one solar panel. A computer system including one or more processors and memory storing one or more programs is also provided. The method comprises executing the one or more programs to perform the following operations at the time the vehicle is turned off. The operations include measuring a current state of charge of the battery, and selecting at least one charge predictor selected from the vehicle location, date, time, vehicle tilt angle, weather at vehicle location and solar panel efficiency, and then (i) calculating an estimated charging schedule based on the current state of charge and the at least one charge predictor and transmitting said charging schedule to a remote location, or (ii) transmitting said current state of charge and said at least one charging predictor to a remote location where a charging schedule is calculated.

According to a second embodiment, a method of determining a future state of charge of a vehicle that is operable using a rechargeable stored energy source. The method includes determining a present state of charge of the vehicle and recharging the stored energy source using energy derived from a solar panel. The method further includes using the present state of charge in combination with a tilt angle of the vehicle to predict a future state of charge.

According to a further embodiment, a method for remotely monitoring the state of charge of an at least partially electrically powered vehicle including a rechargeable battery is provided. The method comprises measuring a current state of charge of the battery, and calculating an available range of vehicle operation. The current state of charge and the available range of vehicle operation are transmitted via a wired or internal wireless network to a portable electronic device.

### BRIEF DESCRIPTION OF THE DRAWINGS

The following description and drawings set forth certain illustrative implementations of the disclosure, which are indicative of several exemplary ways in which the various principles of the disclosure may be carried out. The illustrated examples, however, are not exhaustive of the many possible embodiments of the disclosure. Other objects, advantages and novel features of the disclosure will be set forth in the following detailed description of the disclosure when considered in conjunction with the drawings, in which:

FIG. 1 is a perspective view of a prior art vehicle including solar panels;

FIG. 2 is a schematic illustration of the subject charge predicting system;

FIG. 3 is a schematic illustration of a first embodiment implementing the system of FIG. 2;

FIG. 4 is a flow chart of the present protocols at vehicle ignition off;

FIG. 5 is a flow chart of the present protocols with vehicle not charging;

FIG. 6 is a flow chart of the present protocols with vehicle charging.

### DETAILED DESCRIPTION

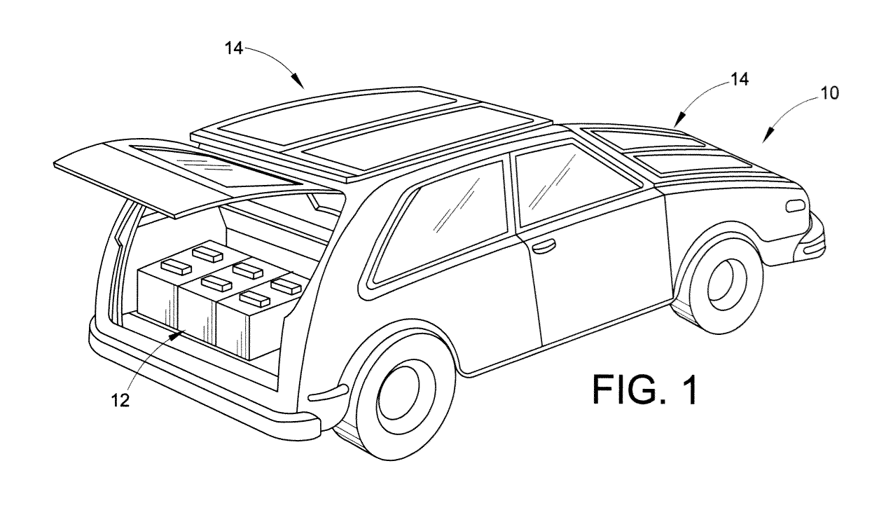

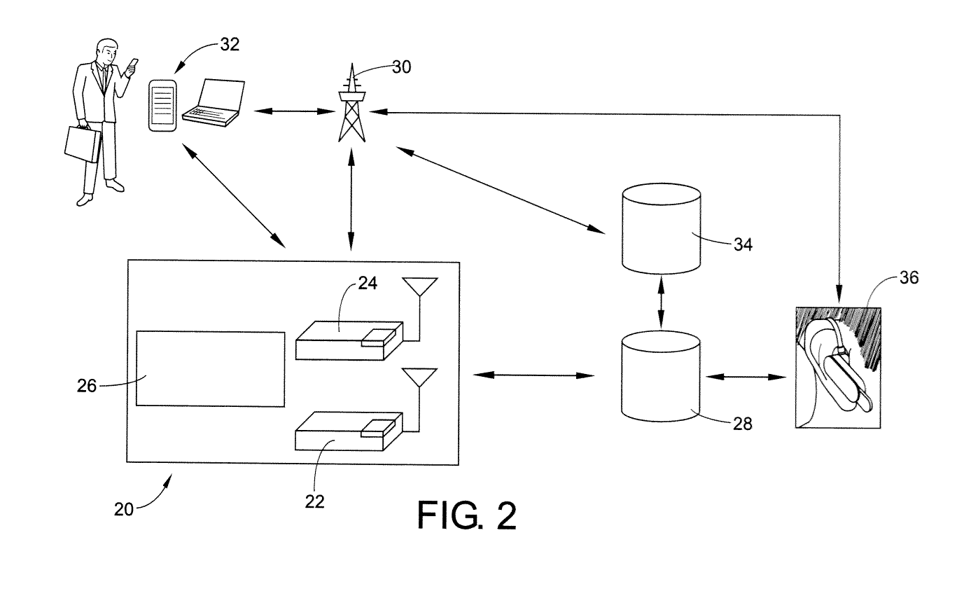

With reference to FIG. 2, the basic system of the present disclosure is set forth. Particularly, an electric or hybrid vehicle (the vehicle of FIG. 1 is a suitable representation) is provided and includes an operations center 20 having integrated navigation unit 22, telematics control unit 24, and processing means 26. Processing means 26 can comprise a computer including one or more processors and memory storing one or more programs. The processing means 26 is capable of monitoring multiple vehicle conditions and controlling multiple vehicle operations. The telematics control unit 24 can function as an embedded vehicle telephone and can be controlled by the processing means 26. The navigation unit 22 includes a GPS function and is similarly integrated with the processing means 26. The navigation unit 22 may communicate directly outwardly via a satellite network 30 or may rely on the telematics control unit 24 to communicate via a cellular network 28 or a satellite network 30. The operations center 20 has access to vehicle parameters and the ability to wake the vehicle and update those parameters.

The operations center 20 is preferably equipped to communicate over numerous available networks including cellular network 28, satellite network 30 and on a local area network directly with a hand held device 32 which can include a mobile phone, a personal data assistant, a computer, or a key fob, as examples. Furthermore, the cellular network can provide for communication via cellular network servers 34 or via cellular network operators 36. In short, an integrated network of communication is provided which allows a remote computer or hand held device to access vehicle data for storage and analysis of vehicle conditions, including charging status.

There are many forms of active communication for a modern day automobile. Unfortunately, many require medium to long range RF communication. This type of communication (which includes cellular phones) may provide poor reception in many real-world situations. Medium range communication cannot provide 100% coverage assurance. For example, the vehicle may be parked in a garage with limited cell coverage. If the operator is unable to communicate with the electric vehicle, the operator may not know if they are able to complete a desired trip, or if they will need to charge the vehicle or for how long charging is required.

The automobile is a special concern considering that it is mobile and the calculation is needed for each new location. This present disclosure provides a method of vehicle charge estimation when other communication methods are not available to the user.

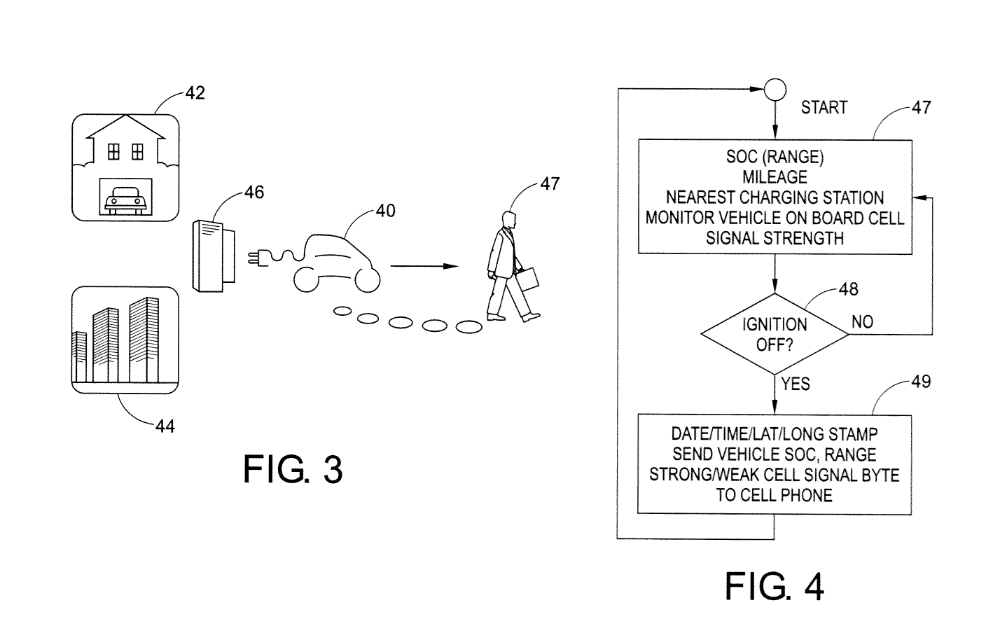

Referring now to FIGS. 3 and 4, a scenario is depicted wherein a vehicle operator 38 turns off (ignition off cycle) an electric vehicle 40. The vehicle 40 can be parked, for example, in a home environment 42 or a work environment 44, including a charging station 46. Included within the meaning of the phrase charging station are solar panels, plug/cord for a standard outlet and/or a plug/cord for a rapid charge facility.

The operation center 20, at ignition off cycle, can communicate information contained within the vehicle processing means 26 and navigation unit 22 via telematics control unit 24 to a remote location having a computer including programming capable of calculating charge conditions. In addition, the information can be communicated to a hand held device via the wireless local area network or a wired connection. The hand held device similarly contains programming capabilities to calculate charge conditions and/or the ability to communicate relevant data to a remote server having the capability to calculate charge conditions. The communicated information can be state of charge, available range, nearest charging stations and onboard cellular signal strength (meaning whether the vehicle has sufficient cellular strength to communicate). The displayed charging schedule can be a percentage of battery charge at a given time. If the ignition is turned off in an area, for example, an underground parking garage where this is no cellular signal, the last known GPS coordinates are sent to calculate the range available for the next trip.

The steps are depicted in a flow chart (FIG. 4) wherein operation center 20 is at least substantially continuously monitoring at least the state of charge, mileage range, nearest charging station, on board cell signal strength via the GPS navigation unit and other on board systems (step 47). At step 48, the vehicle is notified of ignition “off”. If no notification of ignition off is received at least substantially continual updating of the parameters of step 47 are conducted. At ignition “off” yes, information such as date, time, vehicle GPS location, vehicle state of charge, range, and cell phone signal strength can be transmitted to the hand held device via the local area wireless network or through a wire connection such as USB port.

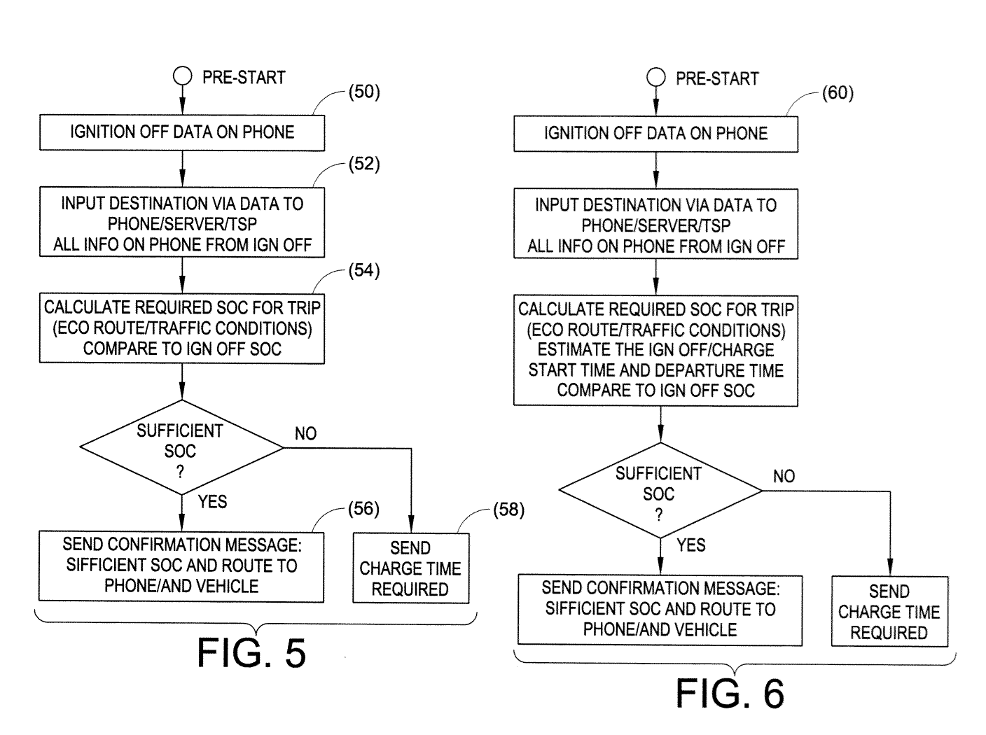

Referring now to FIG. 5, the advantage of the present disclosure is demonstrated when remote hand held device communication with the vehicle is unavailable. In FIG. 5, no vehicle charging is occurring. More particularly, as set forth in FIGS. 3 and 4, at ignition “off”, data is transferred to the phone or other hand held electronic device via the wireless local area network or a wired connection (step 50). The information may be retrieved and processed in accord with the following directly on the hand held device via the wireless local area network or via a wired connection or may be communicated to a computer or server from the hand held device when cellular signal is available. A desired further future destination is input into the hand held device, or communicated to the computer/server if the information on the hand held device has been transferred (step 54). The information retrieved at ignition “off” is used on the hand held device to determine if the state of charge is sufficient for the trip. Such calculations can include the various recognized factors such as traffic conditions, route, etc. as compared to the state of charge at ignition off (step 54). If sufficient state of charge exists (step 56), a confirmation message is generated by the hand held device or sent to the hand held device from the remote server and optionally to the vehicle. If insufficient state of charge exists, a message is displayed or sent concerning necessary time to complete sufficient recharging (step 58).

Referring again to FIG. 5, if a bad cell signal and/or vehicle not charging information is a condition, there is no need to communicate to the vehicle, because the information on the hand held device can communicate with the cellular network server, to get the latest traffic conditions to confirm sufficient state of charge. Prior to the trip start the operator can check the hand held device to determine if a sufficient charge exists for the trip destination. If okay, he or she can proceed to the vehicle with confidence in the ability to reach the necessary destination. If there is insufficient state of charge, a reply can be displayed that a charge before departure must be completed for a specific period of time and/or identify a charging station en route.

Referring now to FIG. 6, a further scenario is set forth wherein vehicle is charging underway. Prior to restarting the vehicle, the ignition “off” data is communicated to the hand held device over the local area network or wired connection (step 60). A desired destination is input into the hand held device or a server if the information on the hand held device from ignition “off” (62) has been transferred to the remote server. In accord with step 62, the hand held device or the remote server calculates the required state of charge for a trip, considering traditional factors such as route and traffic conditions and an estimation is made of the remaining charging time required. More particularly, in a situation where there is a bad vehicle cell signal and the vehicle is charging, there is no need to communicate to the vehicle. Rather, information on the hand held device communicates with the cellular network server to get the latest traffic conditions and confirm sufficient state of charge. Prior to trip start, the operator can check the hand held device to determine if there is sufficient state of charge for trip destination. If the result is okay, the operator can proceed to the vehicle. If insufficient state of charge exists, an information display shows the remaining time necessary to complete sufficient charging is depicted.

The connection between the hand held device and the vehicle can be, for example, via Bluetooth wireless or a wired connection (ex. USB). As is apparent the hand held device is equipped with software configured to keep a local cache of information on the device sufficient to calculate the information outlined above. The system can communicate with the vehicle when it is within range (˜100 ft. max for Bluetooth) and allows for data transfer.

Each of the protocols of FIG. 2-6, and indeed any type of electric or hybrid vehicle charging program, can allow solar charging of the vehicle. Several conditions directly impact the charging rate of batteries when charged by solar panels in an automotive environment. These factors can be initially measured and then predicted for their impact on the charging performance for a timeframe after communication from the vehicle has been broken. If there is communication between the vehicle and a hand held device or a remote computer that data will be predictive of future state of charge.

Factors that can affect charging are vehicle GPS location; vehicle bearing; weather conditions (cloud cover, rain, fog, snow, haze, smog and pollutant levels; temperature); time of day; date; tilt angle of vehicle (front to back and side to side); shading of the vehicle (structures or vegetation); and panel cleanliness. Many of these factors are known such as available sunshine at a particular time on a particular date or are publically available information such as weather conditions. Other conditions can be determined via appropriate sensors in communication with the operations center 20, such as GPS location, vehicle bearing, shading of the solar panels, panel cleanliness (efficiency), and vehicle tilt (i.e. front to back and side to side orientation).

These factors can be used to fit the current vehicle panel situation to tested, predicted charging curves. Fitting to predetermined charging curves allows the system to calculate the charge for any particular moment. In addition, by monitoring some of these conditions on a neighborhood or city level, the hand held device or remote computer/server an predict what the level of charge will be even when the conditions continue to change. In fact, monitoring at least three and preferably more of these factors can provide a best prediction.

An example of this dynamic prediction is the ability for a program to predict the current charge of a system after hours of solar panel charging. When the operator leaves the vehicle the current information is stored on his hand held device. When requested, the user can see the predicted level of charge. This prediction can be done either on the portable device or by sending the initial vehicle conditions to a computer/server. The program can take the collected vehicle factors and separate them into two categories, static and dynamic. The static category consists of factors that are unlikely to change (vehicle location, bearing, tilt angle etc.). The dynamic category consist of factors such as weather conditions and time of day. The calculation is able to take the initial starting points of the factors and adjust the dynamic factors to determine current or future charging status. The calculation of vehicle tilt is advantageous to consider in view of the change of relative orientation of the solar panels to sunlight throughout the day. Vehicle tilt can be readily determined via an inclinometer, accelerometer or other type of commonly employed tilt sensor. The result of the calculations is the ability to have a good estimate of the vehicle charge at any time. It is envisioned that the protocols are sufficiently dynamic to function both when the vehicle is parked and when it is in operation.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A method for determining the state of charge of a vehicle, said vehicle including a battery rechargeable by at least one solar panel, and a computer system including one or more processors and memory storing one or more programs, said method comprising executing the one or more programs to perform the following operations at the time the vehicle is turned off, measuring a current state of charge of said battery, selecting at least one charge predictor from the group consisting of the vehicle geographic location, date, time, vehicle tilt angle, weather at vehicle location, solar panel efficiency, and combinations thereof, and performing a further step of:
(i) calculating an estimated charging schedule based on said current state of charge and said at least one charge predictor and transmitting said charging schedule to a remote location, or
(ii) transmitting said current state of charge and said at least one charge predictor to a remote location where a charging schedule is calculated.

2. The method of claim 1 wherein said remote location is selected from the group consisting of a mobile phone, a personal data assistant, a computer, a key fob and combinations thereof.

3. The method of claim 2 wherein said remote location is a mobile phone.

4. The method of claim 1 wherein at least three charge predictors are selected.

5. The method of claim 1 wherein solar panel efficiency is determined by assessing cleanliness of the panel.

6. The method of claim wherein said vehicle comprises an electric vehicle.

7. The method of claim 1 wherein said at least one charge predictor is vehicle tilt angle.

8. The method of claim 1 wherein said remote location includes a processor and one or more programs to calculate said charging schedule.

9. The method of claim 1 wherein said charging schedule comprises a percentage of battery charge at a given time.

10. A method for predicting a future state of charge of a vehicle including a rechargeable stored energy source, said method comprising determining a present state of charge of said vehicle, recharging said stored energy source using energy derived from a solar panel and calculating in combination with a tilt angle of the vehicle a future state of charge of said vehicle.

11. The method of claim 10 wherein said calculating step further relies on the vehicle geographic location, date, time and weather at the vehicle location.

12. The method of claim 10 being performed when said vehicle is parked or is in operation.

13. The method of claim 10 wherein said future state of charge is communicated to a remote location.

14. The method of claim 11 wherein said future rate of charge is respectfully calculated over time.

15. A method for remotely monitoring the state of charge of an at least partially electrically powered vehicle, said vehicle including a rechargeable battery, said method comprising measuring a current state of charge of said battery, and transmitting said current state of charge via one or both a wired and an internal wireless connection to a portable electronic device.

16. The method of claim herein said portable electronic device comprises a mobile phone.

17. The method of claim 16 wherein said portable electronic device includes software adapted to calculate an available range of vehicle operation based on said current state of charge and a charging condition of said battery.

18. The method of claim 17 wherein said software includes a step of indicating if said battery is charging and recalculating said available range of vehicle operation based on charging time.

19. The method of claim 18 wherein said step of indicating if said battery is charging includes identifying if said charging is through the vehicle being plugged in or from a solar panel.

20. The method claim 18 wherein said charging is provided by a solar panel and said mobile phone further receives a vehicle tilt angle and utilizing said tilt angle in calculating said available range of vehicle operation.
